(19) United States
(12) Patent Application Publication
(10) Pub. No.: US 2019/0385482 A1
(43) Pub. Date: Dec. 19, 2019

(54) INFORMATION PROCESSING APPARATUS, INFORMATION PROCESSING METHOD, AND PROGRAM

(71) Applicant: TOYOTA JIDOSHA KABUSHIKI KAISHA, Toyota-shi (JP)

(72) Inventors: Fumiki OHTANI, Toyota-shi (JP); Hirofumi KAMIMARU, Fukuoka-shi (JP); Riho MATSUO, Nagoya-shi (JP); Shodai KATO, Toyota-shi (JP); Atsushi YOSHIDA, Tokyo (JP); Shunsuke TANIMORI, Susono-shi (JP)

(73) Assignee: TOYOTA JIDOSHA KABUSHIKI KAISHA, Toyota-shi (JP)

(21) Appl. No.: 16/425,138

(22) Filed: May 29, 2019

(30) Foreign Application Priority Data
Jun. 13, 2018 (JP) 2018-113007

(51) Int. Cl. G09B 19/16; G09B 19/14; G09B 5/00

(52) U.S. Cl. CPC G09B 19/167; G09B 5/00; G09B 19/14

(57) ABSTRACT

An information processing apparatus includes a controller. The controller, in a case where a learning between a teacher user who is a user giving teachings and a student user who is a user receiving teachings is performed in a carpool vehicle, when it is determined, based on information indicating whether a driver of the vehicle is the teacher user or the student user, that the driver is the student user, provides information related to the determination to multiple users selected as carpool members in the vehicle.

### CROSS REFERENCE TO RELATED APPLICATION

This application claims the benefit of Japanese Patent Application No. 2018-113007, filed on Jun. 13, 2018, which is hereby incorporated by reference herein in its entirety.

### BACKGROUND

### Technical Field

The present disclosure relates to an information processing apparatus, an information processing method, and a program.

### Description of the Related Art

An autonomous driving vehicle is known which switches between a normal automatic driving mode in which switching to a manual driving mode can be done through a predetermined operation by a driver, and a forced automatic driving mode in which switching to a manual driving mode is disabled, depending on the usage situation of a portable device of the driver (see, for example, Patent document 1). In recent years, a way of traveling has been widely spread in which multiple users ride on the same vehicle together. In relation to this way of traveling, techniques for matching multiple users have been developed.

### CITATION LIST

### Patent Document

[Patent document 1] Japanese Patent Laid-Open No. 2017-117489

[Patent document 2] U.S. Patent Application Publication No. 2017/0351990

### SUMMARY

An objective of the present disclosure is to support smooth running of a carpool vehicle in which a learning is performed.

One aspect of the present disclosure is an information processing apparatus including a controller. The controller, in a case where a learning between a teacher user who is a user giving teachings and a student user who is a user receiving teachings is performed in a carpool vehicle, when it is determined, based on information indicating whether a driver of the vehicle is the teacher user or the student user, that the driver is the student user, provides information related to the determination to multiple users selected as carpool members in the vehicle.

Aspects of the present disclosure include the disclosure of a method and the disclosure of a program related to the information processing apparatus.

The present disclosure can support smooth running of a carpool vehicle in which a learning is performed.

### BRIEF DESCRIPTION OF THE DRAWINGS

FIG. 1 is a diagram illustrating a schematic configuration of a carpool support system according to an embodiment;

FIG. 2 is a block diagram schematically illustrating one example of configurations of an in-car apparatus, a user terminal, and a server constituting the carpool support system according to an embodiment;

FIG. 3 is a diagram illustrating an example of the functional configuration of the server;

FIG. 4 is a diagram illustrating an example of a table configuration of travel information about a driving user;

FIG. 5 is a diagram illustrating an example of the table configuration of travel information about a passenger user;

FIG. 6 is a diagram illustrating an example of the table configuration of status information according to a first embodiment;

FIG. 7 is a diagram illustrating one example of matching upon which notice processing is performed according to the first embodiment;

FIG. 8 is a diagram illustrating an example of matching upon which notice processing is not performed according to the first embodiment;

FIG. 9 is a diagram illustrating an example of a functional configuration of the user terminal;

FIG. 10 is a diagram illustrating one example of a screen for inputting user information, travel information, and status information shown on an output unit of the user terminal;

FIG. 11 is a diagram illustrating an example of a functional configuration of the in-car apparatus;

FIG. 12 is a flow chart of matching processing according to an embodiment;

FIG. 13 is a flow chart illustrating a flow for executing notice processing according to the first embodiment;

FIG. 14 is a diagram illustrating a flow of the operation of the carpool support system;

FIG. 15 is a diagram illustrating an example of a table configuration of status information according to a second embodiment;

FIG. 16 is a diagram illustrating one example of a screen for inputting user information, travel information, and status information shown on an output unit of a user terminal;

FIG. 17 is a diagram illustrating one example of matching upon which notice processing is performed according to the second embodiment;

FIG. 18 is a diagram illustrating one example of matching upon which notice processing is not performed according to the second embodiment; and

FIG. 19 is a flow chart illustrating a flow for executing notice processing according to the second embodiment.

### DESCRIPTION OF THE EMBODIMENTS

In an information processing apparatus which is one aspect of the present disclosure, in a case of execution of learning between users in a carpool, if the vehicle's driver is determined to be a user who receives teachings related to the learning (a student user), information corresponding to the determination is provided to each user. For example, information is input to a terminal possessed by each user in a carpool or the vehicle that the users ride on so that each user receives the notice that the vehicle's driver is a student user. This determination is made based on information indicating whether the vehicle's driver corresponds to a teacher user or a student user. If the vehicle's driver corresponds to a teacher user or a student user may be predetermined or determined by a controller based on information obtained by each user. A teacher user is a user who gives teachings related to a learning content that the student user demands. Note that a user to be not involved by learning may ride on the vehicle. A learning is provided, for example, verbally. Providing a learning in a vehicle in this manner promotes a carpool in the vehicle.

Here, a student user is required to think more than a teacher user during the learning. For this reason, if the driving user is a student user, he/she has to think about the learning, which may result in actions required for the driving user becoming inadequate. In contrast, combining a passenger user in such a manner that the driving user does not become a student user may decrease opportunities of carpool. Therefore, matching with other users is performed regardless of whether or not the driver is a student user, so that a decrease in opportunities of carpool is suppressed. Here, matching is to set a combination of users to ride on the same vehicle. Note that a combination of a vehicle and a user may be set through matching. Against the above-described risk, in a case where the driving user is a student user, the controller provides information so that this fact is noticed to each user. The timing when this information is provided or the timing when each user is noticed coincides, for example, with the completion of matching or the time when the user rides on the vehicle. For example, each user may be noticed at predetermined time intervals or text may be constantly output on a display mounted in the vehicle. This notice can trigger the driver to abandon a learning or the teacher user to take the student user's place driving. It also can trigger the driving user to drive more carefully. Thus, actions required for the driving user becoming inadequate can be suppressed. This enables smooth running of the vehicle.

Concrete embodiments of the present disclosure will now be described with reference to the accompanying drawings. Configurations of the embodiments are examples, and the present disclosure is not limited to the configurations of the embodiments.

### First Embodiment

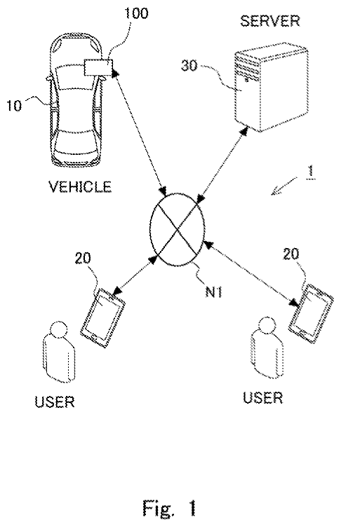

FIG. 1 is a diagram illustrating a schematic configuration of a carpool support system 1 according to this embodiment. The carpool support system 1 performs matching so that multiple users ride on one vehicle 10, and generates a travel path along which matched users can ride. In a case where users demand a certain learning, matching is performed so that a user teaching the content of learning (a user acting as a teacher; hereinafter referred to as teacher user) and a user receiving teachings (a user acting as a student; hereinafter referred to as student user) can ride on the same vehicle 10. The description below is based on the assumption that an English lesson is given as a learning in the vehicle 10.

In a case where a driver of vehicle 10 is a student user, with the carpool support system 1 according to this embodiment, information about this fact is transmitted to user terminals 20 possessed by matched users or the vehicle 10, and the user terminals 20 or the vehicle 10 notice the users. The driver of vehicle 10 will hereinafter be referred to as a “driving user”, and the carpool partners other than the driving user (non-drivers) are referred to as “passenger users”. When not distinguished from each other, the driving user and passenger users are simply referred to as a “user”. Although the description of this embodiment is based on the assumption that the driving user drives the vehicle 10 by himself/herself, this is not necessarily the case: for example, in an autonomous driving vehicle which switches from automatic driving to manual driving in a predetermined state, a user who can be a driver upon switching to a manual driving mode may become the driving user. Further, a driving user is not limited to the owner of the vehicle 10.

In the example illustrated in FIG. 1, the carpool support system 1 includes an in-ear apparatus 100 installed in the vehicle 10, user terminals 20, and a server 30. The in-car apparatus 100, the user terminals 20, and the server 30 are connected to each other via a network N1. Note that the network N1 is, for example, a worldwide public communication network, such as the Internet, and may be a wide area network (WAN) or other communication networks. In addition, the network N1 may include a telephone communication network such as that for cellular phones, or a wireless communication network such as Wi-Fi. Although two user terminals 20 are illustrated in FIG. 1, multiple users each possess a user terminal 20 and as many user terminals 20 as users exist. Further, although a single vehicle 10 is illustrated in FIG. 1, more than one vehicles 10 exist.

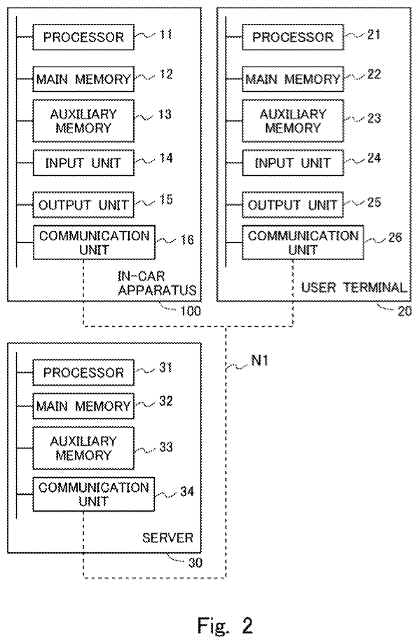

Hardware configurations and functional configurations of the in-car apparatus 100, the user terminals 20, and the server 30 will now be described with reference to FIG. 2. FIG. 2 is a block diagram schematically illustrating one example of configurations of the in-car apparatus 100, the user terminals 20, and the server 30 constituting the carpool support system 1 according to this embodiment.

The server 30 has a typical computer configuration. The server 30 includes a processor 31, a main memory 32, an auxiliary memory 33, and a communication unit 34. They are connected to each other via a bus.

The processor 31 is a central processing unit (CPU), a digital signal processor (DSP), or the like. The processor 31 controls the server 30 and performs various logic operations for information processing. The processor 31 functions as a controller. The main memory 32 is a random access memory (RAM), read only memory (ROM), or the like. The auxiliary memory 33 is an erasable programmable ROM (EPROM), a hard disk drive (HDD), a removal medium, or the like. The auxiliary memory 33 stores an operating system (OS), various programs, various tables, and the like. The processor 31 loads the programs stored in the auxiliary memory 33 onto the work area of the main memory 32 and executes it, and the components are controlled through this execution of the programs. Thus, the server 30 implements a function meeting a predetermined objective. The main memory 32 and the auxiliary memory 33 are computer-readable recording media. Note that the server 30 may be a single computer or multiple computers in cooperation. Information stored in the auxiliary memory 33 may be stored in the main memory 32. Information stored in the main memory 32 may be stored in the auxiliary memory 33.

The communication unit 34 is a unit configured to communicate with the user terminals 20 and the in-car apparatus 100 via the network N1. The communication unit 34 is, for example, a wireless communication circuit for a local area network (LAN) interface board or wireless communication. The LAN interface board or the wireless communication circuit is connected to the network N1.

Note that a sequence of processing executed in the server 30 can be executed with hardware or software.

The user terminals 20 will now be described. Each user terminal 20 is, for example, a smartphone, a cellular phone, a tablet terminal, a personal information terminal, a wearable computer (such as a smartwatch), a personal computer (PC), or other compact computers. Each user terminal 20 includes a processor 21, a main memory 22, an auxiliary memory 23, an input unit 24, an output unit 25, and a communication unit 26. They are connected to each other via a bus. Description of the processor 21, the main memory 22, and the auxiliary memory 23, which are similar to the processor 31, the main memory 32, and the auxiliary memory 33 in the server 30, will be omitted.

The input unit 24 is a unit configured to receive an input operation from a user, for example, a touch screen, a push-button, or the like. The output unit 25 is a unit configured to show information to the user, for example, a liquid crystal display (LCD), an electroluminescence (EL) panel, a speaker, a lamp, or the like. The input unit 24 and the output unit 25 may constitute one touch screen display. The communication unit 26 is a communication unit configured to connect the user terminals 20 to the network N1. The communication unit 26 is, for example, a circuit for communication with other devices (for example, the server 30) via the network N1 by utilizing a mobile communication service (a telecommunication network, such as 3rd Generation (3G) or long term evolution (LTE), or a wireless communication, such as Wi-Fi).

The in-car apparatus 100 of the vehicle 10 will now be described. The in-car apparatus 100 includes a processor 11, a main memory 12, an auxiliary memory 13, an input unit 14, an output unit 15, and a communication unit 16. They are connected to each other via a bus. They are similar to the processor 21, the main memory 22, the auxiliary memory 23, the input unit 24, the output unit 25, and the communication unit 26 of the user terminal 20, and their description will therefore be omitted.

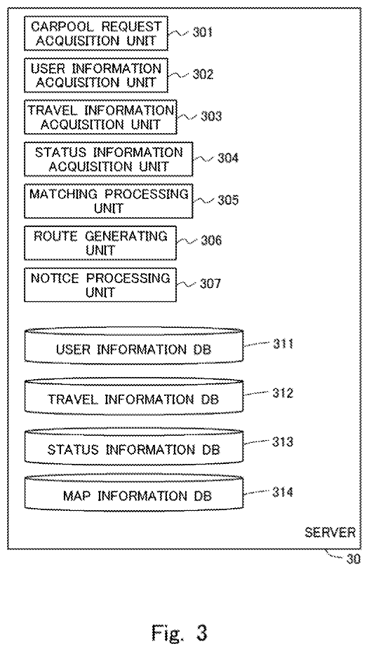

A function of the server 30 will now foe explained. FIG. 3 is a diagram illustrating an example of a functional configuration of the server 30. The server 30 includes, as functional components, a carpool request acquisition unit 301, a user information acquisition unit 302, a travel information acquisition unit 303, a status information acquisition unit 304, a matching processing unit 305, a route generating unit 306, a notice processing unit 307, a user information DB 311, a travel information DB 312, a status information DB 313, and a map information DB 314. The processor 31 in the server 30 executes processing in the carpool request acquisition unit 301, the user information acquisition unit 302, the travel information acquisition unit 303, the status information acquisition unit 304, the matching processing unit 305, the route generating unit 306, and the notice processing unit 307, using computer programs in the main memory 32. Note that any one of the functional components or part of their processing may be executed with a hardware circuit.

The user information DB 311, the travel information DB 312, the status information DB 313, and the map information DB 314 are constructed when programs in a database management system (DBMS) executed by the processor 31 manage data stored in the auxiliary memory 33. The user information DB 311, the travel information DB 312, the status information DB 313, and the map information DB 314 are, for example, a relational database.

Note that any one of the functional components of the server 30 or part of their processing may be executed with a different computer connected to the network N1.

The carpool request acquisition unit 301 acquires a carpool request from a user who demands a carpool (a carpool desiring user). Examples of this user include driving users and passenger users. A carpool request is information that includes a user's identifier and is used to request matching between the user and other users. A carpool request is transmitted from the user terminal 20 to the server 30. The user information acquisition unit 302 acquires information of the user that has transmitted the carpool request (user information). The user information includes, for example, a user ID associated with the user. The user ID is an identifier unique to each other. User information corresponding to the user ID (for example, a name and address, and in a case of a driving user, a car type, car color, car number, and the like) may be pre-registered by the user through the user terminal 20 or may be transmitted from the user terminal 20 together with the carpool request. This user information is stored in the user information DB 311. The user information DB 311 is made up with the user information stored in the auxiliary memory 33 and is where association between the user and the user information is performed.

The travel information acquisition unit 303 acquires travel information about a user who demands a carpool. The travel information is information that is transmitted from the user terminal 20 to the server 30 together with the carpool request, and is related to a user's current location, destination, and travel date and time. Upon acquisition of travel information, the travel information acquisition unit 303 stores the travel information in the travel information DB 312. The travel information DB 312 is made up with the travel information stored in the auxiliary memory 33 and is where association between the user and the travel information is performed.

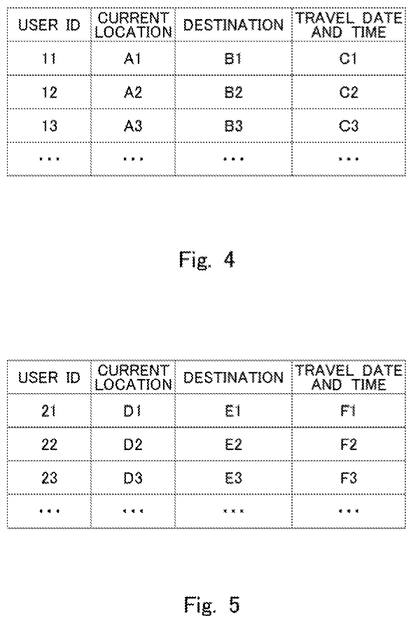

A structure of travel information stored in the travel information DB 312 will now be described with reference to FIGS. 4 and 5. FIG. 4 is a diagram illustrating an example of a table configuration of travel information about a driving user. FIG. 5 is a diagram illustrating an example of the table configuration of travel information about a passenger user. Note that whether a user who demands a carpool is a driving user or a passenger user may be prestored in the user information DB 311 in the state where it is associated with a user ID, and may be included in status information which will be described later. A driving user travel information table and a passenger user travel information table each include the fields of user ID, current location, destination, and travel date and time. In the user ID field, identification information for identifying users is input, in the current location field, information indicating the current locations of users is input. A current location of a passenger user is a location where he/she demands to get the vehicle 10. In the destination field, information indicating the destinations of users is input. The current location and the destination are, for example, represented by a latitude and a longitude. Note that, in the driving user's current location field, information indicating the current location of the vehicle 10 may be input. In the travel date and time field, information indicating a desired date and time of a carpool is input.

Next, the status information acquisition unit 304 acquires status information about a user who demands a carpool. The status information is information transmitted with the user terminal 20 to the server 30 together with the carpool request, and is information indicating whether the user is a driving user or a passenger user, information indicating whether the user is a teacher user or a student user, and information related to a learning objective of the user. Upon acquisition of the status information, the status information acquisition unit 304 stores the status information in the status information DB 313. The status information DB 313 is made up with the status information stored in the auxiliary memory 33 and is where association between the user and the status information is performed.

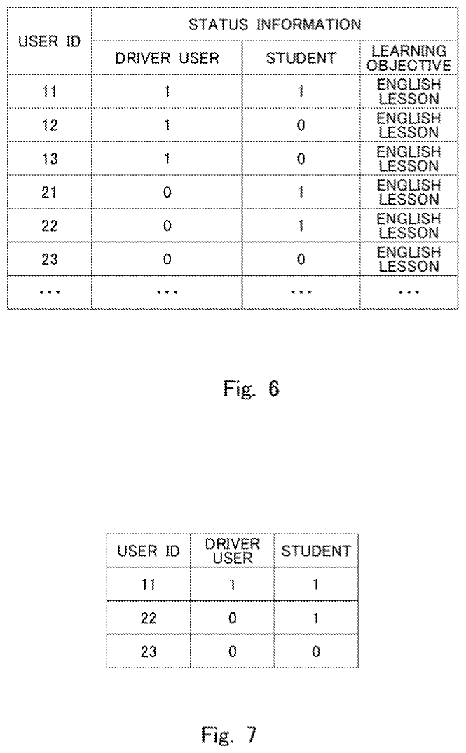

The structure of the status information stored in the status information DB 313 will now be described with reference to FIG. 6. FIG. 6 is a diagram illustrating an example of the table configuration of the status information. A status information table includes user IDs, the distinction between a driving user and a passenger user, the distinction between a teacher user and a student user, fields of learning objective. In the user ID field, identification information for identifying users is input. In the field of the distinction between the driving user and the passenger user, information indicating whether the user who demands a carpool is a driving user or a passenger user is input. In the example illustrated in FIG. 6, “1” is input for a driving user, and “0” is input for a passenger user. In the field of the distinction between the teacher user and the student user, information indicating whether the user is a teacher user or a student user is input. In the example illustrated in FIG. 6, “0” is input when the user is a teacher user, and “1” is input when the user is a student user. In the learning objective field, information indicating an objective of learning the user demanding a carpool desires is input. A learning objective is, in a case of a student user, information corresponding to the content of a learning that the student user demands to receive, and, in a case of a teacher user, information corresponding to the content of a learning that the teacher user demands to teach. Although an English lesson is given as an example of a learning objective in FIG. 6, a learning objective may be any objective aimed at mastering knowledge or skills and not limited to an English lesson. Users having no learning objective may exist. For users having no learning objective, information indicating the absence of a learning objective may be input or nothing may be input in the field of the distinction between the teacher user and the student user.

The matching processing unit 305 will now be described. The matching processing unit 305 performs matching between a driving user and passenger users. The matching processing unit 305 searches for passenger users whose current location and destination are within an area a predetermined distance from a scheduled route of the travel of the driving user on the driving user's travel date and time. The scheduled route of the travel is generated based on the driving user's current location and destination and the map information stored in the map information DB 314. Note that the predetermined distance is a distance suitable for a carpool, and the area a predetermined distance away is, for example, an area in the same district. Further, the matching processing unit 305 compares driving user's status information with passenger user's status information, and matches a driving user having the same learning objective as that of the passenger users. The map information DB 314 stores, as the map information, for example, link data on roads (links), node data on node points, intersection data on intersections, search data for searching for routes, facility data on facilities, search data for searching for locations, and the like.

The route generating unit 306 generates a travel path passing the current locations and destinations of the driving user and the passenger users matched through the matching processing unit 305. The travel path is generated so that it can be a path according to predetermined rules, such as a path along which the shortest travel distance of the vehicle 10 is achieved or a path along which the shortest travel time of the vehicle 10 is achieved. The route generating unit 306 transmits the generated travel path to the in-car apparatus 100 of the vehicle 10 and the user terminals 20.

The notice processing unit 307 refers to the status information of each user matched through the matching processing unit 305, and determines whether or not a user serving as a driving user and a student user at the same time exist. The notice processing unit 307 executes notice processing when it is determined that a user serving as a driving user and a student user at the same time exist. Notice processing involves generating information (hereinafter also referred to as notice information) for notifying that the driving user is a student user, and transmitting the generated notice information to the in-car apparatus 100 or the user terminal 20 of each matched user. Notice information may be transmitted immediately after its generation, may be transmitted in the timing when the user gets in the vehicle, or may be transmitted at predetermined time intervals. Since the notice processing unit 307 transmits notice information to the in-car apparatus 100 or the user terminals 20, the notice information is provided to each user.

FIG. 7 is a diagram illustrating an example of matching upon which the notice processing is performed. The user IDs in FIG. 7 correspond to the user IDs illustrated in FIGS. 4, 5, and 6. The user with a user ID of “11” is a driving user, and the users with user IDs of “22” and “23” are passenger users. In addition, the users with user IDs of “11” and “22” are student users, and the user with a user ID of “23” is a teacher user. Therefore, the user with a user ID of “11” serves as a driving user and a student user at the same time, and the notice processing unit 307 therefore performs notice processing.

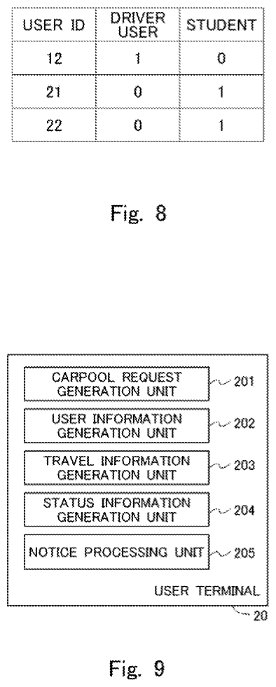

In contrast, FIG. 8 is a diagram illustrating an example of matching upon which the notice processing is not performed. The user IDs in FIG. 8 correspond to the user IDs illustrated in FIGS. 4, 5, and 6. The user with a user ID of “12” is a driving user, and the users with user IDs of “21” and “22” are passenger users. The user with a user ID of “12” is a teacher user, and the users with user IDs of “21” and “22” are student users. Thus, no user serves as a driving user and a student user at the same time, so that the notice processing unit 307 does not perform the notice processing.

A function of the user terminal 20 will now be explained. FIG. 9 is a diagram illustrating an example of a functional configuration of the user terminal 20. Each user terminal 20 includes, as functional components, a carpool request generation unit 201, a user information generation unit 202, a travel information generation unit 203, a status information generation unit 204, and a notice processing unit 205. The processor 21 in the user terminal 20 executes processing in the carpool request generation unit 201, the user information generation unit 202, the travel information generation unit 203, the status information generation unit 204, and the notice processing unit 205, using computer programs in the main memory 22. Note that any one of the functional components or part of their processing may be executed with a hardware circuit.

The carpool request generation unit 201 shows an operating screen on the output unit 25 and generates a user carpool request, according to a user's input to the input unit 24. For example, the carpool request generation unit 201 outputs an icon or the like used to issue a carpool request to a touch screen display, and a carpool request is generated when the user clicks the icon. The carpool request generation unit 201 associates the generated carpool request with a user ID and transmits it to the server 30.

The user information generation unit 202 generates user information. The user information generation unit 202 shows an operating screen for promoting an input of user information on the output unit 25 and generates the user information according to a user's input to the input unit 14. The generated user information is transmitted by the carpool request generation unit 201 to the server 30 together with a carpool request. Note that the user information may be input by the user through the input unit 24 in advance and stored in the auxiliary memory 23 of the user-terminal 20. The user information generation unit 202 may generate the user information based on data stored in the auxiliary memory 23. In addition, the user information generation unit 202 may generate the user information before the carpool request is generated and transmit it to the server 30. For example, the user information may be generated upon user registration and transmitted to the server 30. In this case, the user information is stored in the user information DB 311 of the server 30 in advance.

The travel information generation unit 203 generates user's travel information. The travel information includes a current location, a destination, and a travel date and time. The travel information generation unit 203 shows an operating screen for promoting an input of the travel information on the output unit 25 and generates the travel information according to a user's input to the input unit 14. The generated travel information is transmitted by the carpool request generation unit 201 to the server 30 together with a carpool request. Note that the travel information may be input by the user through the input unit 24 in advance and stored in the auxiliary memory 23 of the user terminal 20. The travel information generation unit 203 may generate the travel information based on data stored in the auxiliary memory 23. In a case where the user terminals 20 have a global positioning system (GPS), the positions of the user terminals 20 may be detected through reception of radio waves transmitted from satellites upon generation of the travel information, and the travel information generation unit 203 may determine these positions of the user terminals 20 as user's current locations. Although driving users input the driving user's current locations to the input unit 24 by themselves in this embodiment, in a case where the in-car apparatus 100 of the vehicle 10 has a GPS, the in-car apparatus 100 may detect the position of the vehicle 10 by receiving radio waves transmitted from satellites and determine this position of the vehicle 10 as a driving user's current location. In this case, the in-car apparatus 100 has the same functions as the travel information generation unit 203. In this case, at predetermined time (for example, 60 seconds) intervals, information about the current location of the vehicle 10 detected through the GPS may be transmitted from the in-car apparatus 100 to the server 30 together with the user ID. The server 30 updates the driving user's current location stored in the travel information DB 312, based on the information transmitted from the in-car apparatus 100,

The status information generation unit 204 generates user's status information. The status information includes information indicating whether the user is a driving user or a passenger user, information indicating whether the user is a teacher user or a student user, and a user's learning objective. The status information generation unit 204 shows an operating screen for promoting an input of the status information on the output unit 25 and generates the status information according to a user's input to the input unit. 14. The generated status information is transmitted by the carpool request generation unit 201 to the server 30 together with a carpool request. Note that, the status information may be input by the user through the input unit 24 in advance and stored in the auxiliary memory 23 of the user terminal 20. The status information generation unit 204 may generate the status information based on data stored in the auxiliary memory 23. In addition, the status information generation unit 204 may generate the status information before the carpool request is generated and transmit it to the server 30.

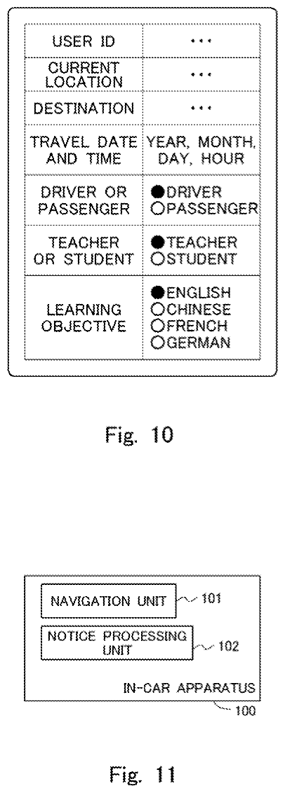

FIG. 10 is a diagram illustrating one example of a screen for inputting the user information, travel information, and status information shown on the output unit 25 of the user terminal 20. For the user ID, current location, destination, and travel date and time, the users input text. In addition, whether the user is a driving user or a passenger user, whether the user is a teacher user or a student user, and a learning objective are selected when the user pushes an icon of a button prepared.

Upon reception of the notice information from the server 30, the notice processing unit 205 instructs the output unit 25 to output information indicating this fact. For example, it may be instructed to show text for drawing attention on the screen or draw attention with a sound. Alternatively, a predetermined lamp may be turned on. Alternatively, vibrations may be generated. After receiving the notice information from the server 30, the notice processing unit 205 may draw attention at predetermined time intervals.

A functions of the in-car apparatus 100 of the vehicle 10 will now be described. FIG. 11 is a diagram illustrating an example of a functional configuration of the in-car apparatus 100. Each in-car apparatus 100 includes, as functional components, a navigation unit 101 and a notice processing unit 102. The processor 11 of the in-car apparatus 100 executes processing in the navigation unit 101 and the notice processing unit 102 through computer programs in the main memory 12. Note that any one of the functional components or part of their processing may be executed with a hardware circuit.

The navigation unit 101 shows a map of an area at or around the current location of the vehicle 10 based on the map information stored in the auxiliary memory 13. In addition, upon reception of a travel path from the server 30, the navigation unit 101 guides the path according to the received travel path. At the time, the navigation unit 101 outputs the travel path to the output unit 15 of the in-car apparatus 100. The navigation unit 101 shows, for example, a map and a path on the display or guides travel directions with a sound.

Although the travel paths are generated in the route generating unit 306 of the server 30 in this embodiment, this generation of the travel paths may be performed in the navigation unit 101 of the in-car apparatus 100. In this case, the server 30 transmits the travel information about each user to the in-car apparatus 100, and the navigation unit 101 generates a travel path based on the travel information and the map information stored in the auxiliary memory 13. The map information stored in the auxiliary memory 13 is information equivalent to the map information stored in the map information DB 314 of the server 30.

Upon reception of the notice information from the server 30, the notice processing unit 102 instructs the output unit 15 to output information indicating this fact. For example, it may be instructed to show text for drawing attention on the screen or draw attention with a sound. Alternatively, a predetermined lamp may be turned on. After receiving the notice information from the server 30, attention may be drawn at predetermined time intervals. Alternatively, for example, text for drawing attention may be always shown on the display that shows the map.

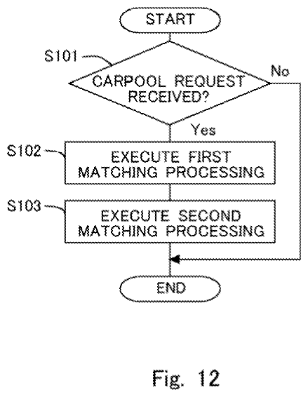

Matching processing executed by the matching processing unit 305 in the server 30 will now be described. FIG. 12 is a flew chart of the matching processing according to this embodiment. The matching processing illustrated in FIG. 12 is repeatedly executed in the matching processing unit 305 at predetermined time intervals. The matching processing is processing for combining a driving user and passenger users.

In step S101, the matching processing unit 305 determines whether or not a carpool request has been transmitted from the user terminal 20. When a positive determination is made in step S101, the process proceeds to step S102, and when a negative determination is made, the flow chart is terminated.

In step S102, a first matching processing is executed based on information stored in the travel information DB 312. In the first matching processing, passenger users whose current location and destination are within an area a predetermined distance from a scheduled route of the travel of the driving user on the driving user's travel date and time are searched and combined. Note that, at this time, more users than passengers that the vehicle 10 can contain may be matched. In the first matching processing, matching may be performed using a well-known matching technique based on the information stored in the travel information DE 312.

Subsequently, in step S103, a second matching processing is executed based on information stored in the status information DB 313. In the second matching processing, passenger users who have the same learning objective as the driving user are extracted among the passenger users matched in the first matching processing and combined. In the second matching processing, matching is performed so that the total number of driving user and passenger users becomes less than or equal to the number of passengers that the vehicle 10 can contain. Note that in the second matching processing, matching may be performed so that only one user registered as a teacher user among the users having the same learning objective rides on the vehicle 10. Alternatively, matching may be performed so that two or more users registered as a teacher user among the users having the same learning objective ride on the vehicle 10. When users having the same learning objective do not exist, users having different learning objectives may be matched, users having no learning objective may be matched, or users may be matched independently of a learning objective. When the driving user does not have a learning objective, passenger users who registered the same learning objective may be matched. Thus, when a user having different learning objective rides on the vehicle 10 together, the opportunities of carpool can be increased.

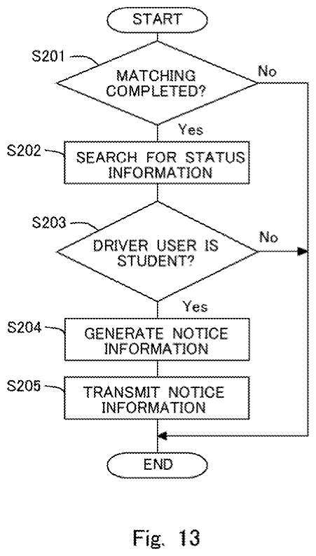

FIG. 13 is a flow chart illustrating a flow for executing the notice processing. This flow chart is executed in the notice processing unit 307 of the server 30 at predetermined time intervals. Note that the flow chart illustrated in FIG. 13 may follow the matching processing illustrated in FIG. 12. In step S201, whether or not user matching by the matching processing unit 305 has been completed is determined. When a positive determination is made in step S201, the process proceeds to step S202, and when a negative determination is made, the flow chart is terminated. In step S202, status information about the matched users is searched. The notice processing unit 307 receives the user IDs of users matched in the matching processing unit 305 from the matching processing unit 305, and reads the status information corresponding to each user ID from the status information DB 313. In step S203, whether or not the driving user is a student user is determined. In other words, whether or not any user who serves as a driving user and a student user at the same time according to the corresponding status information exists among the matched users is determined. When a positive determination is made in step S203, the process proceeds to step S204, and when a negative determination is made, the flow chart is terminated. In a case where a negative determination is made in step S203, information indicating the fact that the driving user is a teacher user may be generated and transmitted to the in-car apparatus 100 or the user terminals 20 of matched users. Meanwhile, in step S204 or later steps, the notice processing is executed. In other words, in step S204, information (notice information) for notifying the fact that the driving user is a student user is generated, and in step S205, the notice information is transmitted to the in-car apparatus 100 or the user terminals 20 of matched users.

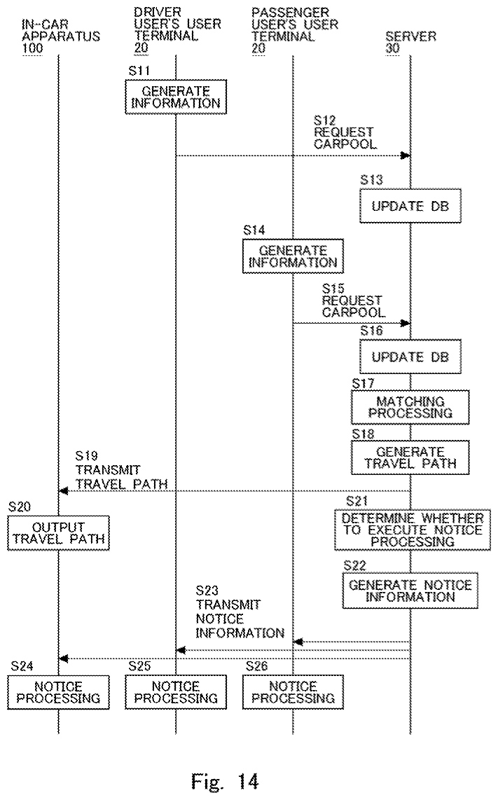

An operation of the carpool support system 1 will now be explained. FIG. 14 is a diagram, illustrating a flow of the operation of the carpool support system 1. When the driving user and passenger users operate the input units 24 of their user terminals 20 to input the user information, the travel information, and the status information, each user terminal 20 generates the carpool request, the user information, the travel information, and the status information (processing in S11 and S14). Subsequently, each user terminal 20 transmits the carpool request, the user information, the travel information, and the status information to the server 30 (processing in S12 and S15). Upon reception of the carpool request, the user information, the travel information, and the status information, the server 30 updates the travel information DB 312 and the status information DB 313 each time (processing in S13 and S16).

In addition, upon reception of the carpool request, the server 30 executes the matching processing (processing in S17). The server 30 searches for users who can join a carpool based on the travel information and status information associated with the user IDs and combines them. Upon completion of matching, the server 30 generates a travel path based on the travel information of each user (processing in S18). Information about the generated travel path is transmitted from the server 30 to the in-car apparatus 100, and the in-car apparatus 100 receiving the information about the travel path outputs the travel path to the output unit 15 and guides the driving user along the travel path (processing in S20). Note that the server 30 may transmit the travel path together with a notification of the completion of the matching to each user terminal 20. Upon reception of the notification of the completion of the matching, in each user terminal 20, the processor 21 outputs the notification of the completion of the matching to the output unit 25.

Further, the server 30 performs processing for determining whether to execute the notice processing (processing in S21). At this time, the server 30 determines whether or not a user serving as a driving user and a student user at the same time exists. When a user serving as a driving user and a student user at the same time exists among the matched users, the server 30 generates notice information (processing in S22) and transmits the notice information to the in-car apparatus 100 and each user terminal 20 (processing in S23). Referring to the flow illustrated FIG. 14, since the notice processing is executed in the in-car apparatus 100 and each user terminal 20, a signal is transmitted to the in-car apparatus 100 and each user terminal 20; alternatively, for example, a signal may be transmitted only to the in-car apparatus 100 and only the in-car apparatus 100 may execute the notice processing. Alternatively, a signal may be transmitted only to the user terminal 20 of the driving user or passenger users, and only the user terminal 20 of the driving user or passenger users may execute the notice processing. Upon reception of the notice information, the in-car apparatus 100 and the user terminals 20 each execute the notice processing (processing in S24, S25, and S26).

As described above, in this embodiment, in a case where a learning between users in a carpool is performed in the vehicle 10, when the driving user is a student user (when a user serving as a driving user and a student user at the same time exists), notifying each user of this fact suppresses actions required for the driving user becoming inadequate. This supports smooth running of the vehicle 10. Since matching is performed independently of whether the driving user is a student user or a teacher user, a carpool in the vehicle 10 can be promoted.

### Second Embodiment

Users input the distinction between a teacher user and a student user to the user terminal 20 by themselves in the first embodiment, while in this embodiment, the server 30 determines whether each user corresponds to a teacher user or student user. Therefore, the server 30 acquires user's learning degrees. A learning degree is a degree of attainment of a learning objective; for example, a user is given a test in the learning objective, and the higher the score of the test is, the higher the learning degree is determined. The test may be given through the user terminal 20. Each user may input the score of a test performed by a predetermined organization to the user terminal 20. In addition, the score of the test performed by the predetermined organization may be transmitted from each terminal possessed by the predetermined organization to the server 30. Each user terminal 20 or the in-car apparatus 100 of the vehicle 10 may have a unit configured to acquire user's sound (voice) and a learning degree may be determined based on the acquired sound. Each user terminal 20 or the in-car apparatus 100 of the vehicle 10 may have a unit configured to take an image of the user and a learning degree may be determined based on the taken image. Each user may input his/her subjective learning degree to the user terminal 20.

Subsequently, the server 30 recognizes the teacher user and student users based on the acquired learning degrees. Upon completion of matching between the driving user and the passenger users, the server 30 acquires the learning degrees of these users and recognizes the user with the highest learning degree as a teacher user. The other users are recognized as student users. Afterwards, the server 30 determines whether or not the driving user is a student user and executes the notice processing when the driving user is a student user.

The description below is based on the assumption that the users have taken a predetermined test in advance and the users input the score to the user terminal 20. In this case, a test score corresponds to a learning degree. The server 30 generates information indicating whether the user is a teacher user or a student user based on the learning degree of the user. For this reason, this embodiment differs from the first embodiment in the processing in the status information acquisition unit 304 and the notice processing unit 307. Besides, the status information stored in the status information DB 313 is different. Points different from those in the first embodiment will be mainly explained below.

The status information acquired by the status information acquisition unit 304 is information indicating whether the user is a driving user or a passenger user, information indicating whether the user is a teacher user or a student user, and information about the user's learning objective. Here, information indicating whether the user is a teacher user or a student user is information generated based on the user's score of the predetermined test and representing that score. Upon acquisition of the status information, the status information acquisition unit 304 stores the status information in the status information DB 313.

The structure of status information stored in the status information DB 313 will now be described with reference to FIG. 15. FIG. 15 is a diagram illustrating an example of the table configuration of the status information. A status information table includes the user's IDs, the distinction between a driving user and a passenger user, the test scores, and fields of the learning objective. The user ID field, the field of the distinction between driving user and passenger user, and the learning objective field are the same as those illustrated in FIG. 6. In the test score field, information representing the user's scores of the predetermined test is input. In the example illustrated in FIG. 15, the higher the score is, the higher the user's learning degree is.

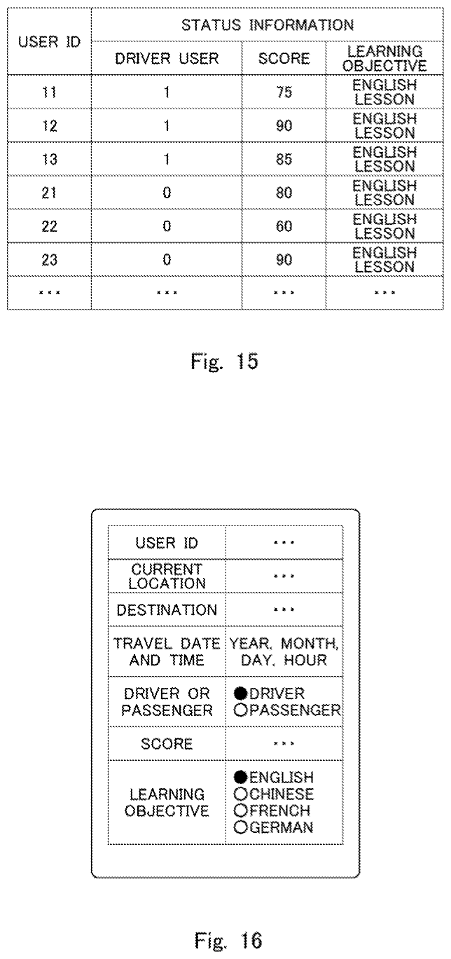

FIG. 16 is a diagram illustrating one example of a screen for inputting the user information, travel information, and status information shown on the output unit 25 of the user terminal 20. For the user ID, current location, destination, travel date and time, and test score, the users input text. In addition, whether the user is a driving user or a passenger user and the learning objective are selected when the user pushes an icon of a button prepared.

In addition, the notice processing unit 307 refers to the status information of each user matched through the matching processing unit 305, and determines whether or not the driving user is a student user. The notice processing unit 307 refers to the test score of each matched user and recognizes the user with the highest score as a teacher user, and the other users as student users. The notice processing unit 307 executes the notice processing when it is determined that the driving user is a student user.

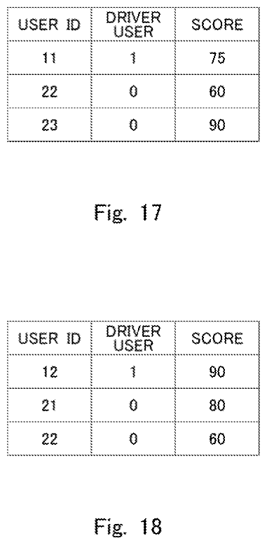

FIG. 17 is a diagram illustrating one example of matching upon which the notice processing is performed. The user IDs in FIG. 17 correspond to the user IDs illustrated in FIGS. 4, 5, and 15. The user with a user ID of “11” is a driving user, and the users with user IDs of “22” and “23” are passenger users. Further, since the user with the highest test score is the user with a user ID of “23”, the notice processing unit 307 recognizes the user with a user ID of “23” as a teacher user and the user with a user ID of “11” and the user with a user ID of “22” as student users. Therefore, the user with a user ID of “11” serves as a driving user and a student user at the same time, and the notice processing unit 307 therefore performs the notice processing.

In contrast, FIG. 18 is a diagram illustrating one example of matching upon which the notice processing is not performed. The user IDs in FIG. 18 correspond to the user IDs illustrated in FIGS. 4, 5, and 15. The user with a user ID of “12” is a driving user, and the users with user IDs of “21” and “22” are passenger users. Further, since the user with the highest test score is the user with a user ID of “12”, the notice processing unit 307 recognizes the user with a user ID of “12” as a teacher user and the user with a user ID of “21” and the user with a user ID of “22” as student users. Thus, no user serves as a driving user and a student user at the same time, so that the notice processing unit 307 does not perform the notice processing.

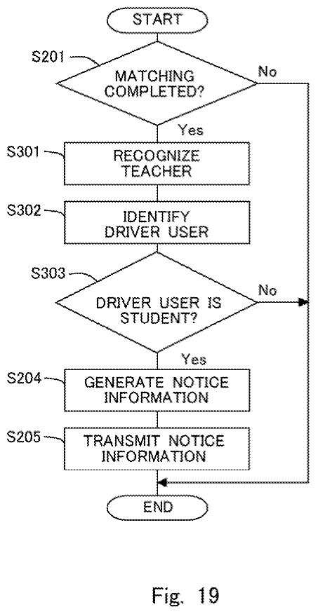

FIG. 19 is a flow chart illustrating a flow for executing the notice processing. This flow chart is executed in the notice processing unit 307 of the server 30 at predetermined time intervals. Note that a step in which the same processing as in the flow chart illustrated in FIG. 13 is performed is denoted by the same reference numeral as the corresponding step and its description will be omitted.

In the flow chart illustrated in FIG. 19, if a positive determination is made in step S201, the process proceeds to step S301. In step S301, among the users matched by the matching processing unit 305, a teacher user is recognized. The notice processing unit 307 receives the user IDs of users matched by the matching processing unit 305 from the matching processing unit 305, and reads test scores corresponding to the user IDs from the status information DB 313. Subsequently, the user with the highest score is recognized as a teacher user. Next, a driving user is identified in step S302. The notice processing unit 307 reads information indicating whether the user is a driving user or a passenger user from the status information DB 313, and identifies a driving user.

In step S303, whether or not the driving user is a student user is determined. Here, if the user ID of the user recognized as a teacher user in step S301 and the user ID of the user identified as a driving user in step S302 are different, it is determined that the driving user is a student user. When a positive determination is made in step S303, the process proceeds to step S204, and when a negative determination is made, the flow chart is terminated.

As described above, in this embodiment, in a case where a learning between users in a carpool is performed in the vehicle 10, when the driving user is a student user (when a user serving as a driving user and a student user at the same tine exists), notifying each user of this fact suppresses actions required for the driving user becoming inadequate. This supports smooth running of the vehicle 10. Further, since matching is performed independently of whether the driving user is a student user or a teacher user, a carpool in the vehicle 10 can be promoted.

### Other Embodiments

The above-described embodiment is merely illustrative and appropriate modification can be made without departing from the scope of the present disclosure.

The processing and units described in this disclosure can be freely combined unless technical inconsistencies arise.

In addition, processing supposed to be done with one device according to the above description may be executed with multiple devices. Alternatively, processing supposed to be done with different devices according to the above description may be executed with one device. In a computer system, the type of hardware configuration (server configuration) used to implement each function can be flexibly changed.

The present disclosure can be implemented when a computer program having the functions that have been described in the above embodiment implemented is supplied to a computer, and one or more processors in the computer read and execute the program. Such a computer program may be provided to the computer via a non-transitory computer-readable memory medium that can be connected to the computer's system bus or via a network. Examples of non-transitory computer-readable memory medium include any type of disks such as a magnetic disk (such as a floppy (registered trademark) disk and hard disk drive (HDD)), and an optical disk (such as CD-ROM, a DVD disk, and a Blu-ray disk), a read only memory (ROM), a random access memory (RAM), EPROM, EEPROM, a magnetic card, a flash memory, an optical card, and any type of media suitable for storing electronic instructions.

What is claimed is:

1. An information processing apparatus comprising a controller, the controller, in a case where a learning between a teacher user who is a user giving teachings and a student user who is a user receiving teachings is performed in a carpool vehicle, when it is determined, based on information indicating whether a driver of the vehicle is the teacher user or the student user, that, the driver is the student user, providing information related to the determination to multiple users selected as carpool members in the vehicle.

2. The information processing apparatus according to claim 1, wherein the controller determines whether or not the driver is the student user, based on information corresponding to each of the multiple users and indicating whether the user is the vehicle's driver or non-driver and information corresponding to each of the multiple users and indicating whether the user is the teacher user or the student user.

3. The information processing apparatus according to claim 1, wherein the controller selects the members, based on information about learning objectives of carpool demanding users who are users demanding a carpool in the vehicle.

4. The information processing apparatus according to claim 1, wherein the controller acquires information indicating whether the user is the driver or the non-driver and information indicating whether the user is the teacher user or the student user from a terminal possessed by each of the multiple users.

5. The information processing apparatus according to claim 1, wherein the controller generates information indicating whether the user is the teacher user or the student user, based on a learning degree of each of the multiple users.

6. An information processing method comprising the steps of:
in a case where a learning between a teacher user who is a user giving teachings and a student user who is a user receiving teachings is performed in a carpool vehicle, determining, based on information indicating whether a driver of the vehicle is the teacher user or the student user, whether or not the driver is the student user; and
when it is determined that the driver is the student user, providing information related to the determination to multiple users selected as carpool members in the vehicle.

7. A program for causing the information processing method according to claim 6 to be executed by a computer.
